(19) United States
(12) Patent Application Publication
(10) Pub. No.: US 2023/0261990 A1
(43) Pub. Date: Aug. 17, 2023

(54) METHODS FOR EXCHANGING CONTENT ROUTING INFORMATION IN EXCLUSIVE PATH ROUTING OVERLAY NETWORK

(71) Applicant: Peter CHACKO, Kolenchery (IN)

(72) Inventor: Peter CHACKO, Kolenchery (IN)

(21) Appl. No.: 18/087,195

(22) Filed: Dec. 22, 2022

(30) Foreign Application Priority Data
Dec. 22, 2021 (IN) 202141058711

(51) Int. Cl. H04L 45/64; H04L 9/40

(52) U.S. Cl. CPC H04L 45/64; H04L 63/0272; H04L 63/166; H04L 63/20

(57) ABSTRACT

The present disclosure relates to routing information exchange to content forwarding routers (DTCs) from USC controller, making up an exclusive-path routing paradigm, across an overlay network. USC maintain the content routing information base. A method for implementing an overlay network of Data Transport Controllers with source-routed data forwarding, based on transport protocol information with split-transport is disclosed. The method includes populating and updating content forwarding data to Data Transport Controller (DTC) nodes at regular intervals using a universal security controller (USC); uploading the content to original Data Transport Controller (DTC) nodes, converting the uploaded content into Split-Partition (SP) fragments at origin DTC, forwarding data, across content routers by a plurality of DTC nodes, recovering the original content from the SP fragments at terminal DTC node.

### PRIORITY STATEMENT

The present application hereby claims priority to Indian patent application number “202141058711” filed on Dec. 22, 2022, the entire content of which are hereby incorporated herein by reference.

### TECHNICAL FIELD

The present disclosure is generally related to Zero Trust, Content Routing technologies across a Wide Area Network, without fully relying upon Encryption based technologies such as IPsec/VPNs and more particularly related to methods for updating information associated with content forwarding next hops, forming an overlay network of geographic storage routing tunnels implemented at transport layer, without changing underlying packet routing at lower layers in the protocol stack.

### BACKGROUND

Existing network security technologies like L2, L3, L4 or MPLS based VPNs and secure tunnels offers only encryption/computational-based security. An intervening device on the network path, can recreate the application-level data stream, if the device placed before any network device that the stream goes through. Though sometimes packets can traverse through different underlay router, often times, packets typically end up going through the same set of network devices as a common hop, if routing paths are stable as routing protocols work on the principles of least cost path. An intervening network device can do wire-tapping, recreate full encrypted data stream and recover the full data from end-to-end encrypted data, leveraging the compute power of a quantum computer, if available. If this is an FTP file transfer or email data sent across a VPN, this means that a cyber attacker can now have access to full encrypted file or message.

This is not a serious problem now, but few years from now, when quantum computing becomes ubiquitously available, this assumption is broken. Cyber attackers now will “wire-tap” and keep it, and when quantum computers become available, break the encryption, and cause massive data exposure. As a result, a need for a radical security in-motion is needed, clearly.

### SUMMARY

This summary is provided to introduce a selection of concepts in simple manners that are further described in the detailed description of the disclosure. This summary is not intended to identify key or essential inventive concepts of the subject matter nor is it intended to determine the scope of the disclosure.

To overcome at least some of the above-mentioned problems, methods comprising: the steps for segmenting an application data stream into multiple, information-theoretic fragments, and further comprising steps for sending the fragmented data, across multiple sessions and across exclusive paths, and further comprising steps for utilizing an overlay network while sending the fragmented data is needed.

It is preferable to have a method that leads to sending the actual data packets in the underlay routed across different intervening devices. Due to this double whammy mechanisms on segmenting an application data stream across sessions and routing the content across exclusive paths in the overlay network will cause the data to move through different routers, and thereby revolutionize wide area data transport security, in the context of quantum computing attacks.

A method for implementing an overlay network of Data Transport Controllers with source-routed data forwarding, based on transport protocol information with split-transport is disclosed. The method includes populating and updating content forwarding data to Data Transport Controller (DTC) nodes at regular intervals using a universal security controller (USC); uploading the content to original Data Transport Controller (DTC) nodes, converting the uploaded content into Split-Partition (SP) fragments at connected Data nodes or at origin DTC, forwarding SP fragments, across hops acting as content routers by a plurality of DTC nodes, recovering the original content from the SP fragments at terminal DTC node or at an attached Data nodes, wherein all DTC nodes and USC are connected through an underlay network running existing routing protocols and forward packets based on existing art.

A method for exchanging various content forwarding information and content across transport level content routing overlay architecture is disclosed. The method includes populating and updating content forwarding information to DTC nodes at regular intervals of time using a universal security controller (USC), forwarding SP fragments across a plurality of DTC nodes, wherein the DTC nodes are connected through an underlay network running existing routing protocols based on lower layer protocol information such as IP or MPLS labels, and comprising the steps of creating Exclusive Path List Table (EPLT) through PLT Generation operation, at USC, exchanging the PLT Entries to every DTC node through CRP (CFR Route Pull) operation between any DTC node, executing Next Hop Update (NHU) operation, executing Route List Pruning (RLP) operation at every DTC node, creating the exclusive content forwarding router (ECFR) List for content forwarding, at any DTC node, preparing next hop table for every Route ID at every DTC, establishing transport level connection with next hop DTCs, forming the split-connected, exclusive path circuit (EPC) mesh for every Route Identifier, whereas data nodes and DTC nodes are communicatively connected together in a Wide Area Network or part of the same system and exchange control commands, security parameters, configuration parameters with USC.

A method for forwarding content across DTC nodes, across an overlay network is disclosed. The method includes converting the content into SP fragments, and sending SP fragments to any DTC node from Data nodes; forwarding split partition (SP) fragments across a set of exclusive list of DTC nodes, using a plurality of DTC nodes; storing the SP fragments, using a plurality of Data nodes before or after being transported over the overlay; and populating and updating content forwarding paths to DTC nodes at regular intervals of time using a universal security controller (USC), wherein the USC node exchanges executable instructions with DTC nodes, all DTC nodes are connected through an underlay network running existing routing protocols, and further comprising the steps of preparing Exclusive Path Routes to every other DTC node, updating the SP Fragments with separate DTC List for each SP fragment, through Route-Selection operation, executing exclusive path forwarding (EPF) operation of each SP fragment from origin DTC node to terminal DTC node in the DTC List, receiving the SP fragment at the terminal DTC, whereas data nodes and DTC nodes are communicatively connected together in a Wide Area Network or part of the same system and exchange control commands, security parameters, configuration parameters with USC.

A method for Exclusive-Path content forwarding across an overlay network is disclosed. The method implemented by a computer system that includes a processor coupled to a memory comprising a plurality of DTC nodes communicatively connected across one another and to a USC controller; DTC node comprising the instructions for establishing transport level connections to any of the DTC node and USC, executing Route-Learning operation, creating the exclusive content forwarding router (DTC) List for content forwarding, creating Path List Table (PLT) through PLT Learning operation, at USC, exchanging the PLT Entries to every DTC node through CRP operation between any of the DTC node and USC, executing Route List Pruning (RLP) operation at every DTC node at regular intervals, preparing Exclusive Path Routes to every other DTC nodes, updating the content with separate DTC List, executing exclusive path forwarding (EPF) operation for content, terminating the EPF at terminal DTC node, whereas data nodes and DTC nodes are communicatively connected together in a Wide Area Network or part of the same system and exchange control commands, security parameters, configuration parameters with USC.

A system for Cyber-Secured, Exclusive Path Routing at transport protocol level is disclosed. The system includes a plurality of data nodes either connected to DTC nodes or a part of DTC node for converting content into SP fragments and uploading to DTC nodes and a universal security controller (USC) that populates and updates content forwarding data to DTC nodes at regular intervals of time, wherein all DTC nodes are connected through an underlay network running existing routing protocols based on lower layer protocol information such as IP or MPLS labels, and comprising USC having the instructions for: creating Exclusive Path List Table (EPLT) through PLT Generation operation and executing CRM operations at every DTC, a plurality of DTCs connected across a Wide area network over a transport protocol having the instructions for, exchanging the PLT Entries to every DTC node through CRP (DTC Route Pull) operation at any DTC node, executing New Route Identifier discovery operation, executing Next Hop Update (NHU) operation, executing Route List Pruning (RLP) operation at every DTC node, creating the exclusive content forwarding router (ECFR) List for content forwarding, at any DTC node, preparing next hop table for every Route ID at every DTC, establishing transport level connection with next hop DTCs, forming the split-connected, exclusive path circuit (EPC) mesh for every Route Identifier, whereas data nodes and DTC nodes are communicatively connected together in a Wide Area Network or part of the same system and exchange control commands, security parameters, configuration parameters with USC.

The summary above is illustrative only and is not intended to be in any way limiting. Further aspects, exemplary embodiments, and features will become apparent by reference to the drawings and the following detailed description.

### BRIEF DESCRIPTION OF DRAWINGS

These and other features, aspects, and advantages of the exemplary embodiments can be better understood when the following detailed description is read with reference to the accompanying drawings in which like characters represent like parts throughout the drawings, wherein:

FIG. 1 is a block diagram that illustrates Route List distribution and Content Forwarding aspects across Exclusive list of DTC nodes controller, according to an embodiment of the present disclosure;

FIG. 2 is a block diagram that illustrates various DTC nodes that can be specifically hosted in multiple countries with inter-country data movement control aspects shown, according to an embodiment of the present disclosure;

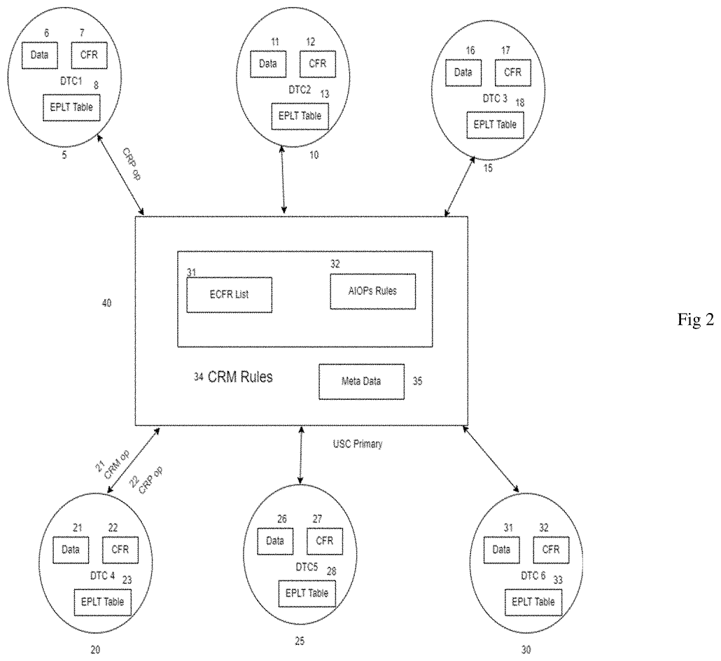

FIG. 3 depicts the other connected DTC controllers as each DTC view its connected DTC peers in the overlay, for 6 DTC nodes as an example, according to an embodiment of the present disclosure;

FIG. 4 depicts the other connected DTC controllers as each DTC view its connected DTC peers in the overlay, for 6 DTC nodes as an example, according to an embodiment of the present disclosure;

FIG. 5 depicts the other connected DTC controllers as each DTC view its connected DTC peers in the overlay, for 6 DTC nodes as an example, according to an embodiment of the present disclosure;

FIG. 6 depicts the other connected DTC controllers as each DTC view its connected DTC peers in the overlay, for 6 DTC nodes as an example, according to an embodiment of the present disclosure;

FIG. 7 depicts the other connected DTC controllers as each DTC view its connected DTC peers in the overlay, for 6 DTC nodes as an example, according to an embodiment of the present disclosure;

FIG. 8 depicts the other connected DTC controllers as each DTC view its connected DTC peers in the overlay, for 6 DTC nodes as an example, according to an embodiment of the present disclosure;

FIG. 9 shows the cross-section details of the DTC controller, according to an embodiment of the present disclosure;

FIG. 10 shows the DTC overlay without SG nodes or USC controller, according to an embodiment of the present disclosure;

FIG. 11 is a block diagram illustrating the theory of operation of data flow between CFRs and USC controllers under the security control operations of USC, indicating separate channels for data transfer, security control and control or configuration exchange, according to an embodiment of the present disclosure;

FIG. 12 shows the DTC overlay without SG nodes or USC controller, according to an embodiment of the present disclosure, according to an embodiment of the present disclosure;

FIG. 13 showing the aspects of data redactions aspect of content fragmentation, according to an embodiment of the present disclosure;

FIG. 14 is a table indicating an example of an exclusive CFR List used in the overlay, according to an embodiment of the present disclosure;

FIG. 15 is a table indicating RIDE parameters and RIM codes used at USC controller, according to an embodiment of the present disclosure;

FIG. 16 is a high-level operational logic of a DTC node, according to an embodiment of the present disclosure;

FIG. 17 is a high-level operational logic of a USC controller, according to an embodiment of the present disclosure;

FIG. 18 is set of tables indicating the EPLT table stored at USC and local CFR list for a specific DTC, according to an embodiment of the present disclosure;

### DETAILED DESCRIPTION OF THE INVENTION

The foregoing description has broadly outlined the features and technical advantages of the present disclosure in order that the detailed description of the disclosure that follows may be better understood. It should be appreciated by those skilled in the art that the conception and specific embodiment disclosed may be readily utilized as a basis for modifying or designing other structures for carrying out the same purposes of the present disclosure. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

The process features or functions of the present disclosure can be implemented by a computing device. As an example, computing device may include enterprise servers, application servers, workstations, personal computers, network computers, network appliances, personal digital assistants, set-top boxes, and personal communication devices.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended. For example, as an aid to understanding, the detail description may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to the present disclosure containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the above detailed description.

The present disclosure is related to methods and system architecture for content forwarding and updating information for content forwarding routers denoted as DTCs or CFRs in the disclosure. Content overlay routing is based upon exclusive path lists of content forwarding routers. Content forwarding routers route content at transport layer, with split connections between hop to hop and route traffic based on the exclusive path, source based next hop routing at application level as an overlay network.

The present disclosure relates to a set of methods and architecture for implementing content forwarding information data exchange methods for an exclusive path data forwarding overlay network across split-transport at every hop. Content is segmented and data is forwarded at segment level, preventing the re-assembly of entire transport session, unlike traditional data forwarding at lower layers of the network protocols stack.

It is to be noted that, multiple embodiments can be created out of the claims of the present disclosure by applying to only a subset of the attack scenarios, such as a solution only for data in-motion.

The present disclosure discloses methods of segmenting the application data stream into multiple, information-theoretic fragments, and send it across multiple sessions and across exclusive paths making use of an overlay network, that will cause the actual data packets in the underlay routed across different intervening devices. Due to this pairing of segmentation across sessions and routing the content across exclusive paths in the overlay network that will cause data to move through maximally different underlying network devices of the underlay network, invention can revolutionize wide area data transport security, in the context of quantum computing attacks.

The unique aspects of the present disclosure disclose the way centralized routing information management and exchanging the same to content forwarding routers to dynamically change the routing policies when there is a cyber-attack is detected at any participating content forwarding routers. Centralized security controller detect any cyber-attack and dynamically updates the routing policies and cause some of the DTC nodes update the same, having the affected DTC as part of the local CFR List, essentially freezing out the offending node in the overlay routing network. Data is first segmented and then use separate transport connections to move the segment from hop to hop across an overlay network with an exclusive path routing paradigm. Exclusive paths in the overlay is designed such a way that, when data is actually routed at Layer 2/Layer3 level through an underlay, no two segments flow through the same underlay path, practically speaking, given the observations that in steady state a given transport flow can cause packets go through the same device in a stead state scenarios of underlying routing dynamics Traditional VPNs built upon encryption for privacy which can be broken in the face of quantum computing. Computational security can be challenged and can be broken by quantum computing resources, which is extremely fast for certain computations such as the mathematic side of the encryption whereas information theoretical security is safe in the face of quantum computing based attacks, unless the attacker gets hold of a majority sum of the pieces of the data blocks which is extremely difficult. Whenever there is a security incident observed in any node, every other node marks the offending node as unavailable and uses other backup node to move content through.

In one embodiment, aspects of the present disclosure can be applied to an overlay cloud services or any system having data or metadata assets needing real time data risk mitigation from various attacks. Such systems include single, standalone systems running applications, SMTP based E-mail contents, data base applications like MySQL, ORACLE, MongoDB, Cassandra or any SQL or NoSQL like data stores. The aspects of the present disclosure can be extended to modern IT platforms like cloud-native applications running on Kubernetes based IT stack, Open Stack or any Inter-site data transport or migration systems. The central component of the aspects of the present disclosure is the Data Transport Controller overlay tunnel and Micro-segmented data transfers, operating in lockstep with the commands and controls from Universal Security Controller. Invention can be applied to FTP data traffic or SMTP data traffic to secure file transfer and mail transfer content from various forms of cyber-attacks.

### Significance

The present disclosure acutely is significant as quantum computing is a threat to encryption technologies and industry needs data-centric security readiness beyond encryption. Computational security systems can be broken by enough compute power which is possible once quantum computing is a reality in the next 5-10 years. Though lattice cryptography is the new encryption solution that resists quantum computing, it is not available as part of existing VPN and SSL systems and Storage systems for prime use. Furthermore, encryption systems always must manage crypto keys which are often cumbersome for long term data protection. In addition, the present disclosure offers information theoretic security that does away with all forms of encryption key management as information theory is un-breakable to computing attacks.

Industry has produced many intrusions detection and prevention systems to networks, but no real products for intrusion and mitigation at storage level. This present disclosure offers new way of intrusion detection and mitigation for storage intrusion avoidance for the data in-motion, using information theory. Embodiments of the present disclosure provides a system, architecture and methods to realize end to end, content level intrusion mitigation against ransomware attacks, system intrusion, storage intrusion and crypto breaks for data in-motion.

Some technical terms used in the present disclosure are described below.

Data Transport Controller (also referred also as DTC node or CFR node): This is the core component of the Architecture. Data transport Controller is also referred as DTC node or as Data Transport Gateway (DTG node) or Content Forwarding Routers (CFR node), interchangeably in the disclosure and are placed at various locations in the wide area network or internet, running as physical or virtual machines that moves the data payload to next DTC node or initiating or terminating the content journey in the WAN, moving the content through a pre-meditated secure paths across various DTC nodes. DTCs constantly exchange various security data and inter DTC state data graph (also referred as EPLT Table) with USC. State data graph (or Path List Table) is a graph data structure, based on standard graph data structure or as a list of DTC nodes, representing the available DTC in the overlay network of DTC, the reachability information and also the list of exclusive paths that can be built out of existing DTC nodes from every DTC node to every other DTC node. A plurality of DTC Nodes make up a DTC overlay tunnel or function as a Secure Storage Routing overlay network. DTC route content based on source-routing model based on the entries in the state data graph or PLT entries during the data forwarding operation.

Universal Security Controller Node (USC Node): This is the Security Control Center and Centralized Route distribution part of the present disclosure and is also referred as USC that has various modules integrated for metadata, security contexts, security rules, security policy database and system and storage activity telemetry data captured from different systems. USC is also referred as System controller or Security Controller interchangeably in the specifications.

Storage Gateway or Data nodes: These are terms used for various systems generating and storing content. These systems are connected to CFR over a network or can co-exist with the CFR node. SG node is also referred as Storage gateway or as Data nodes. Different embodiments use different components or combination of this as stand-alone components or as part of embedded modules to CFR nodes or DTC nodes.

Security and system agents: These are systems having programmed instructions to send various security activity or system activity or storage activity related data to USC to enable USC to make the right responsive reactions based on the configured security and data safety policies. These modules are placed as part of Data nodes and DTC Nodes.

Data protection agents or gateways: These systems are deployed at various locations needing data protection services delivered as part of active responses to various cyber or insider attacks. Data protection agents constantly communicate to USC. USC trigger Context Risk Mitigation operations leveraging Data protection gateways.

USC agent module: This is a module that is installed in DTC Node, SG Node and data Node which has system programs that can navigate file systems, look up file changes, compare file modifications against normal changes or abnormal changes such as ransomware activity and also examine system activity such as any abnormal spike in number of processes running indicating a Denial-of-Service Attack. This module can also send system or security specific data or metadata to USC.

Split-connected: This process means that data transfer from original DTC to last DTC is through different connections along the path. When a connection sessions from two end systems is split along the path, multiple transport sessions are used to carry the data, along the way.

Ransomware attack signatures: Ransomware attack pattern is a list of matching storage activity change rules. It can be as simple as a rule that flags the storage activity as a ransomware attack if most of the files in a directory or list of directories are changed in the last 30 minutes that denotes the tell-tale signs of ransomware attacks into the systems. Ransomware can encrypt a file, cause full file change, remove the contents, make drastic configuration changes, rename files, changes of the original file name so on and so forth. Ransomware can do data exfiltration which translates to abnormal data transfer across network. Infection signatures can be used to detect any ransomware attack pattern. There are various methods of detecting ransomware attack signature, like, rate of change of data activity from normal 10 activity profile stored in the USC, rate of change of a file from its normal rate of change, rate of change of different files in a directory and overall file change entropy. Security agents keep on sending various storage activity data to USC for anomaly detection. USC also make use of storage honey spot files that any ransomware will treat as target customer data which will immediately indicate as a storage intrusion to USC. Such honeypot files can be deployed at any system like DTC nodes, protected hosts, data protection gateways or at SG Node modules or at any connected system having critical or sensitive file data stores needing protection from various malware attacks.

USC keeps learning the storage activity patterns and updates its databases on what changes are to be considered as attack signature by continually applying Machine Learning rules against what a Security Administrator flags as normal data change or not.

Security Parameters, Configuration Parameters and Control Commands DTC node, keep running various commands looking for abnormal observations. Examples include a sudden surge of failed SSH login attempts, sudden surge in number of processes, abnormal file changes and so on and so forth. This information, referred as Intrusion Detection (IDE) Events, is collected and sent to USC controller. USC controller then processes it and looks for any rule match and send descriptors of instructions to be executed at DTC node. These response commands are referred as Contextual Risk Mitigation commands or CRM operations. Configuration parameters include the data for proper operation of USC and DTC nodes. And can also include the mode of operation of various components as a standard practice of any IT based operations systems.

Data input operation and Data output operation: This term refers to any method through which a user uploads content or download content from an exemplary embodiment. This also corresponds to data store into DTC tunnel and recovery from the tunnel. This can include an FTP based operation or can include a file copy operation to a Data node embedded in a DTC node or communicatively connected to a DTC node. Data input operation corresponds to the data arrival and Data output corresponds to data release by an end user, such as during a data transfer process.

SP fragments (or also referred as fragments or segments or shards): Embodiments of the present disclosure make use of reed Solomon erasure coding to split the content into different unintelligible partitions. If data is dispersed after encryption, with encryption keys stored in the content itself, each fragment of the content after the split is cryptographically unintelligible. In reed Solomon, a wide combination of N:M is possible, where if a content is split into N pieces, only M pieces needed for fully recovery and any combination of pieces up to M−1 reveals no information.

RIDE parameters: RIDE stands for Real time Intrusion Detection Events and RIDE parameters contains various system activity and storage activity info collected from protected systems as a cyber telemetry mechanism. This includes information such as login failures, binary file metadata, system activity info mined from various system, network and application log files, Input Output activity, memory info and similar machine and system data used to detect any possible intrusion to systems. Whenever USC or SG node receives RIDE parameters, RIM (Realtime Intrusion Mitigation) codes will be generated to mitigate the risks by getting various CRM operations executed at the affected systems.

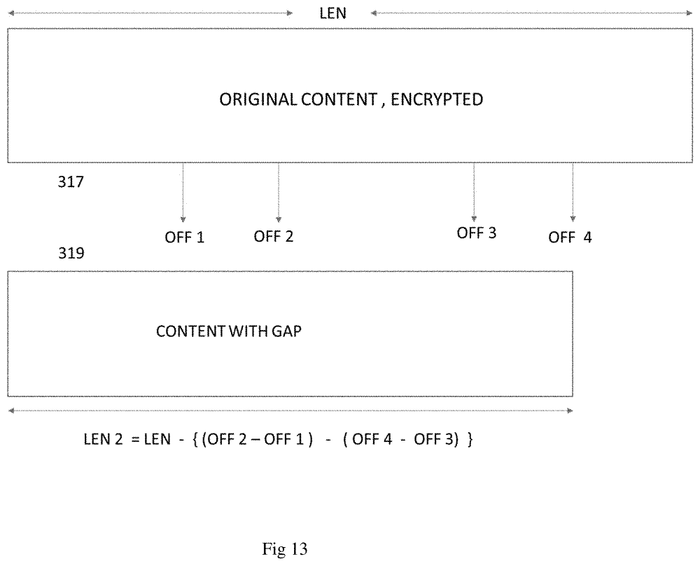

Embodiments of the present disclosure use this mathematics in sending only M pieces of the content across M distinct list of PLT entries in the overlay. Additionally, before erasure coding, content can be redacted with blocks of data removed as gap blocks. Gap blocks, being portions of encrypted and erasure coded content, cannot reveal any information unless inserted back to the original content and apply reverse data engineering operations of RS coding and decryption. Referring to FIG. 13, 317 is an encrypted content in an exemplary embodiment. 319 is the redacted block with data removed from byte level data offsets OFF1 to OFF2 and then OFF3 to OFF4. This redacted data content can be erasure coded and upon final reception at the last DTC, gap block data and gap block metadata information, indicating where the gap offsets are, can be used in re-creating the original content and then decrypt the content using the key contained in the content itself. This method can use various forms of data transformations available in the industry as this in and of itself is not a core part of the invention.

As this gap blocks and gap block metadata can also be separately sent, even without carrying through DTC nodes as in some embodiments, the present disclosure provides sufficient mechanisms of wire-tapping avoidance of data in-transit. Reed Solomon, as it is information theory-based data anonymization, when paired with encryption, cannot be cracked by a quantum computer or other methods, if not enough number of fragments are available. In an embodiment, regular data anonymization techniques of various ways can be used instead of RS coding or in combination with RS coding. Even different forms of erasure coding can be used as appropriate. Embodiments of the present disclosure defines these fragmented portions of the content defines as SP fragments. SP stands for Secret Partition. Recreation of the original content is the reverse process of RS coding to create the original data, then apply the gap block meta data to insert the gap blocks as per the gap block metadata, and then the decryption. Disclosure defines this process as the Content Reassembly or CR operations, which can be done at terminal DTC node or any of the Data nodes attached to terminal DTC.

Binary Verification or BV operations: Any system can be tampered, and any binary file can be replaced by a malicious adversary. DTC node has executable instructions that keep calculating the SHA signature of the known binaries compared against the trusted binary signature as stored in the USC controller or any trusted source as implemented in the embodiment in question.

EP forwarding or Exclusive-Path forwarding or EPF operation: This is the crux of DTC operation. Once SP fragments are created at data node or at the first DTC node as applicable in accordance with the embodiment, every DTC node is to look up the next hop listed in the Content Forwarding Router List (CFR List) for a specific Route identifier. Group of different fragments of content is called a fragment set. Only a subset of the fragments needed for full recovery is transferred which is called a minimal fragment set. Each member of the minimal fragment set receives a unique set of path lists, embedded in the fragment or tagged with fragment, and forwarded by DTCs hop by hop. At every hop, each SP fragment is transferred to next hop in a new transport connection. As end to end delivery of the content between original DTC to target DTC is split across multiple transport connections, and with this method of data transfer, session hijacking or session data exposure risk is even further reduced and this mode of data transfer is referred as split-connected transport in the disclosure, unlike traditional data transfer where data is delivered end to end in a single connection. Every DTC that follows in the CFR list (or referred as PLT entry), looks up the list, and updates the next DTC node information as the next hop and send the fragment to the next DTC and this process repeats until the fragment reaches the last DTC node. This process is also referred as Data forwarding operation. Data forwarding next hop is based on the Path List Table (PLT) entries (also referred as CFR List) similar to source routing paradigm of networking. Routes taken by the content is determined by the data source that picks the CFR list, hence referred as source-routed data forwarding in the disclosure. As each fragment goes through exclusive list of paths shared by USC with each DTC, this process is also referred as Source-Routed, Exclusive Path forwarding. (Referred also as EP Forwarding or EPF operation). Invention makes use of Source Routing principles at transport level and source-routing information on each hop is encoded in the CFR list maintained for each Route identifier. This can also be used for multi-path forwarding in some contexts. First DTC originates the forwarding by picking the exclusive list of DTC nodes through which the CP fragments have to be forwarded through. Last DTC in the list does the termination and CR operations.

USC controller also makes use of data protection agents in addition to security agents deployed at every DTC system. Security agents collect all system activity summary like amount of memory available, number of processes that are running, no of failed login attempts over an SSH connection, list of new binaries installed, list of ports open and similar system information which are collectively termed as intrusion indication parameters or intrusion detection events (IDE). Similarly, storage activity data include various directories and file change and sent to USC over a WAN connection or through a local LAN connection. USC receives various telemetry data and feeds it into log analyzer, which is a tool that can parse and analyze log data and process the data received against configured data security policies and trigger various commands stored in the USC to instruct the protected systems for appropriate actions. These commands include the system command to initiate a bulk data transfer across the overlay to across DTC nodes. This command can be as simple as shutdown operation of some services in affected systems.

In one exemplary embodiment, detailed data and control flow of the present disclosure is explained below. Setup and Architecture of the embodiment is explained first.

Data nodes are connected to USC over any form to TCP/IP based WAN. SG Nodes are connected to at least one of the DTC Nodes that terminate TCP connection or any transport protocol end point such as SCTP, MP-TCP, UDP or DCCP. CFR module has five parts for handling routing, namely originator, distributor, terminator, Tx and Rx. Fragment will hit one of the first DTC Node, as part of the connected mesh network, originator module will create the header and insert it to the content, re-create the file and push to the forwarding queue. Tx module will send the fragment to the next DTC Node. Rx component of the DTC Node receives the new fragment forwarded to it, and hands over to the Distributor component which updates forwarding header containing the source path routing list of different DTC Node if forwarding to upstream DTC node is needed. This process of data-forwarding will repeat until it reaches the terminal DTC Node or egress DTC, in the overlay network. Terminator component of the DTC Node will then pick up the fragment and handover the Data Node attached to the DTC Node. Every DTC Node in the systems contacts USC and receives updated Node state information when an existing DTC goes down or a new one is added to the system. DTC nodes then update the next hop information for each route, in a local table or in an XML (eXtended Markup Language), file, for every Route identifier, a process referred as Next Hop Update (NHU) operation. During NHU operation, a backup DTC node can also be entered in the table if the primary next hop DTC is not reachable. DTC maintain next hop information for every route id in an XML file for easier forwarding operation. This data is referred as Next Hop Table in the disclosure. Originator module will then redraw the source to destination graph for every destination DST Nodes connected to it and re-calculate 3 or 5 or 7 distinct paths for the different fragments of the customer data files or data objects or data blocks to be routed by. All route updates, Node state graph updates are done by CP (Control Plane) Module. CP module and Security Agents can be integrated as a single module or can be implemented as two separate modules.

All communications across various components like data nodes, DTC and USC controller use separate channels for data traffic, security data traffic and control and configuration channel, to avoid a single point of data breach situation of the inter-component communication of the present disclosure.

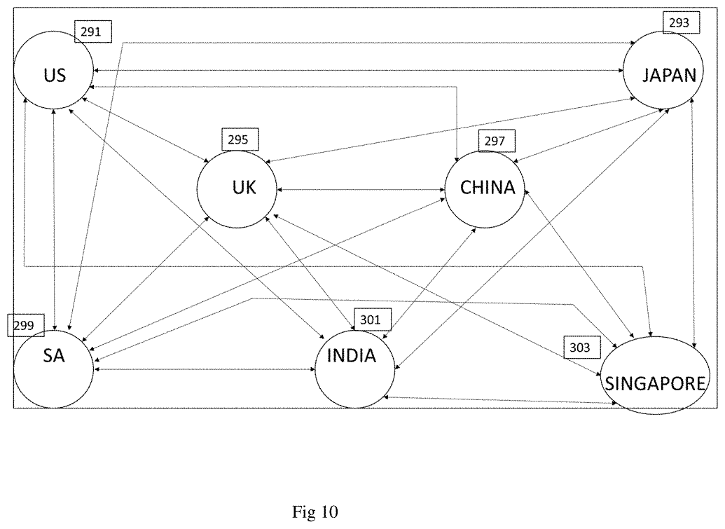

When data is transferred from one system to another system across a WAN connection, data assets are routed across different paths across WAN at content level, as opposed to packet level as in traditional underlay routing. For one embodiment of the present disclosure, a set of Virtual Machines will be hosted in different data centers, in every country with knowledge of country and location information of the systems. This knowledge is stored as a graph in USC. Whenever a data needs to be transmitted from one location to another location in the Wide Area Network, USC can be configured to select a unique path from this graph or can be configured statistically or a combination thereof, for any pair of source and destination locations and will send command to security agent to transmit data, accordingly, including all nodes to be visited for this path. Security agent, after fragmenting files with various technologies to create secret shards, data transformation, and leaving content gap blocks, select each fragment and gap blocks if any, and transfer across a unique path. For example, if one DTC node is stored in a data center in India and another DTC node in US, some fragments can be moved, at network devices level across Atlantic side of the Globe, visiting an intermediate VM in EU, and other fragments will go through Pacific side of the global network infrastructure, visiting an intermediate DTC node through Singapore on the way to US. Referring to FIGS. 10; 291,293,295,297,299,301 and 303 are the DTC nodes hosted in different countries. If a fragment sent from 301 (India) to 303 (SINGAPORE), it will never go through any intermediary located between India (301) and South Africa (299), unless there is a serious router flaps happened because of the way L2/L3 devices work based on the principle of minimal cost-based packet routing to reduce the packet latencies. Embodiments of the present disclosure make use of this core observation by forcing the content to move through a pre-destined path, at content level with connection termination at every hop. Due to this overlay data tunneling, wire-tapping attacks on underlying packet routing systems do not expose packet stream from beginning to end. Further, embodiments of the present disclosure make use of separate channels of communication.

USC distribute relevant routing information to all participating DTC nodes connected in the overlay. USC has the features to freeze out any offending DTC and do automatic path re-routing at DTC level or at an end-to-end path level when it is subjected to a cyber-attack. Overlay network is built upon DTC nodes and Data nodes which are deployed across various geo locations in a Wide Area Network, operating at the control of USC cause every DTC node to download pre-computed state data graph with multiple distinct paths to reach every other DTC node from every DTC node. DTC further learns the changes in the state of other nodes and update its own state data graph. Original DTC create SP fragments and initiates an Exclusive-path content forwarding of the fragments, across the DTC overlay through an exclusive list of DTC nodes and move it to terminal DTC node. USC runs a new DTC algorithm and re-calculate exclusive path list based on its geographical location and re-distribute the updated route information to all DTC nodes. Any DTC node can fail or come back. Node discovery mechanisms learn and update all other nodes to re-compute Exclusive Path List Table.

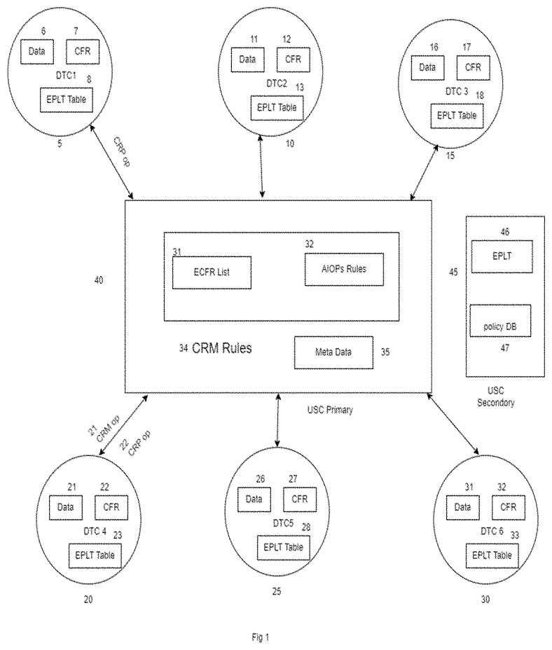

Referring to FIG. 1, Six Data Transport Controllers labeled as DTC1 (5), DTC2 (10), DTC3 (15), DTC4 (20), DTC5 (25), DTC6 (30) connected to USC primary (40) and USC secondary (45). USC secondary will become operational with the same features of USC primary in the event of system failure at USC primary. Each DTC has attached data node CFR node and has local Exclusive Path List Table (EPLT). For example, data node, CFR node and EPLT table of DCT1 are labeled as 6, 7 and 8 respectively. Similarly, 11, 12 and 13 for DTC2 and so on for other DTCs shown. 40 is a USC having master Exclusive Content Forwarding list which is also referred as Exclusive path List Table for each possible Route identifier. A Route identifier identifies a combination of a Source DTC and Destination DTC for content to be transported across. It can be a combination of allowed DTCs for which content transmissions can be established with one as a data source and the other as data destinations. Each possible route can be selected manually by an administrator operator or dynamically, referred as route selection operation. Route Selection process is based on the needs and security policies of different embodiments. When number of DTCs becomes larger, Route-Selection can be done through any feasible algorithm of set theory of finding unique dis-joint sets between two nodes. For each such Route, an initial list of exclusive path is prepared. As more DTC nodes added to the system, it can be added to different rout as a member DTC by either through a manual administration methods or through a simple algorithmic implementation of disjoint set theory. This process is referred as PLT Generation and each entry of a list of DTC for a possible path from source to destination is referred as a PLT entry. In a small network of overlays of a handful of DTCs, simply selecting a disjoint set of DTCs for each route, and grouping it in a list with the transport protocol information including IP addresses and the transport protocol port information of various modules of DTC, including the Rx And Tx process of DTC node. Rx process receive every incoming content from a preceding DTC and Tx process will send the fragment to the next hop, as part of data forwarding (also referred as data-forwarding) operation. DTC will exchange messages with USC for information regarding the routes and DTC participating in the overlay. Information regarding new routes, also known as route learning operation are downloaded to DTC as the message replies from USC for route information exchange messages exchanged between DTC and USC.

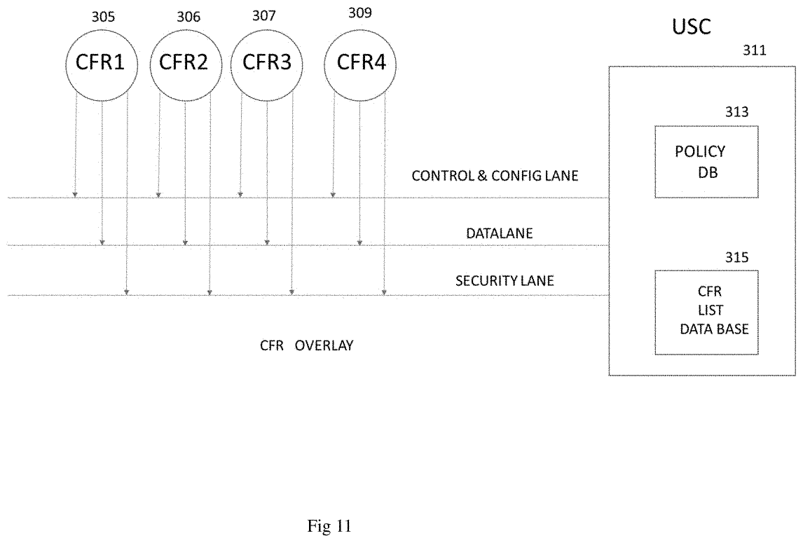

Individual zone concepts can be created and various DTCs can be included in different zones or segments to implement routing policies for geo-graphic based routing and or can be included in a big flat overlay manner Once the master EPLT table is prepared, it is replicated to secondary USC. Individual DTCs keep sending Metadata exchange messages with USC. One, such message is to query any new Routing update with USC, which is referred as CFR Route Pull Message (CRP). USC respond to such messages from DTC with updated EPLT table that include the DTC in question. Referring to FIGS. 11; 305, 306, 307 and 309 are Content Forwarding Routers (also referred as DTCs) and use separate channels for Control or configuration traffic, Data traffic and Security traffic. Control and configuration Lanes will carry traffic containing data from Policy Database (313) and Security Lane will carry traffic for CFR List Database (315) update process. Regular content traffic will go through data lanes. Different channels or lanes can be provided by different network services providers for example, to further increase the security reliability guarantees to defend against the Man-In-the-Middle (MIM) attack scenarios.

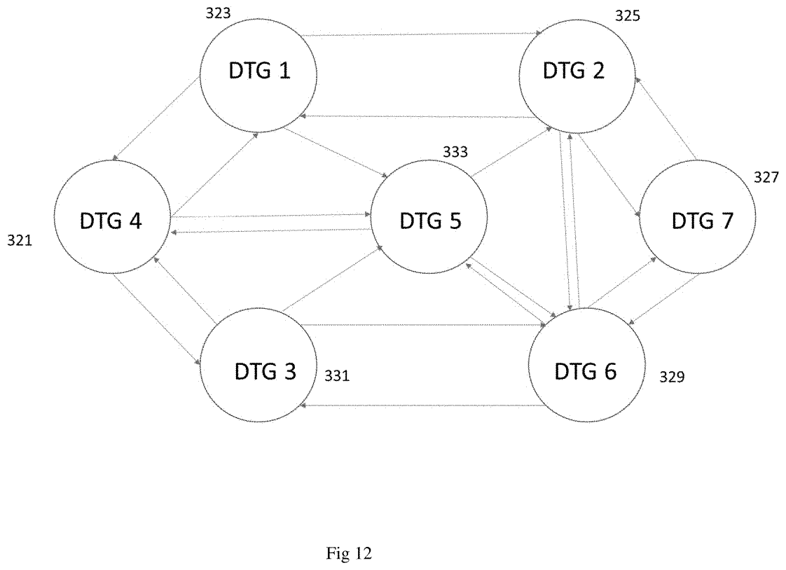

Referring to FIG. 12, an embodiment of a DTC overlay without a USC controller or SG node is shown with all DTCs labeled from DTG1 to DTG7. In this embodiment, DTC node itself has to get the information about other DTC nodes through a manual data entry operation into DTC system or by distributed algorithms or by other means of DTC info collection process such as a cloud API based micro service running in the cloud relaying the node information about every DTC node. Disclosure defines this process as DTC-info collection operations. Every DTC node has to refresh its node state information periodically. Traditional Neighbor reachability and Link state graph building method of underlay, packet level routing cannot be applied here, as all DTC nodes are not L2/L3 devices but operate at application level and a centralized distribution of DTC node info distribution mechanism has to be deployed, in the absence of USC.

This is akin to overlay data routing, at application layer. All state management, end to end delivery of each fragment is handled by USC-DTC pair and keeps track of transmission status of every fragment from every Node to its immediate destination.

Access controls, Authentications services can be applied at various end points, based on the technologies available in the market, like SSL, Multi-factor authentications systems, RBAC based systems as appropriate for providing additional, theoretical safety.

USC is connected to data nodes, and various Data Transport Controllers in at least one of the embodiments of the present disclosure. Security and system agents running in all connected systems. USC also has various metadata for storage security management, security state and system states of various connected parts which is also redundantly stored. When any security or IT risk incident happens, USC engage DTC nodes to deliver various Contextual Risk Mitigation (also referred as CRM) Operations such as taking an immediate backup when there is an imminent hardware fault detected, or an immediate storage migration, across DTC nodes, is performed and system is shutdown when there is an insider caught on data exfiltration. Similarly, appropriate response is performed, such as marking the affected DTC node as un-available and informing other DTC nodes, when there is a ransomware attack detected for example. Other DTC nodes will then remove these DTC nodes from CFR list maintained locally, also known as Route List Pruning (RLP) process. Response also includes generating various threat alerts and updating the USC controller with various attack signatures. CRM operations are facilitated by a command policy database. This contextual data protection service is rendered by the USC controller as the response to a typical system or storage intrusion. New content can enter into the first SG node through a user using the embodiment by storing the content through a file folder service offered by SG node or through any form of data upload service. Data output operation is performed when a user needs to retrieve the content from the embodiment.

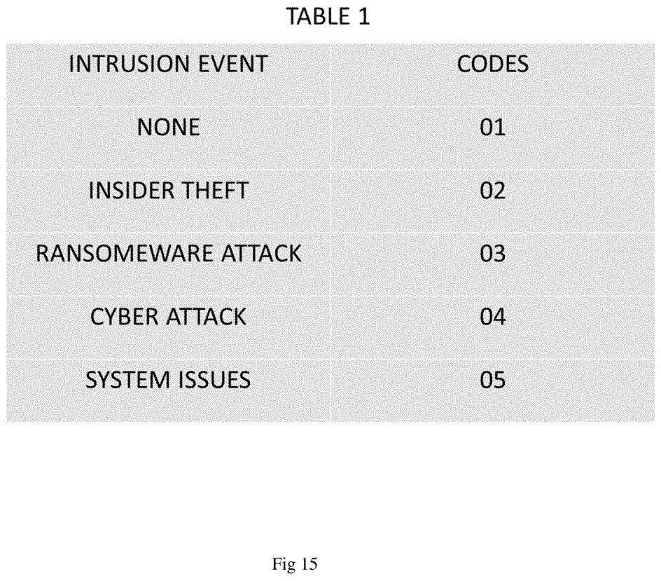

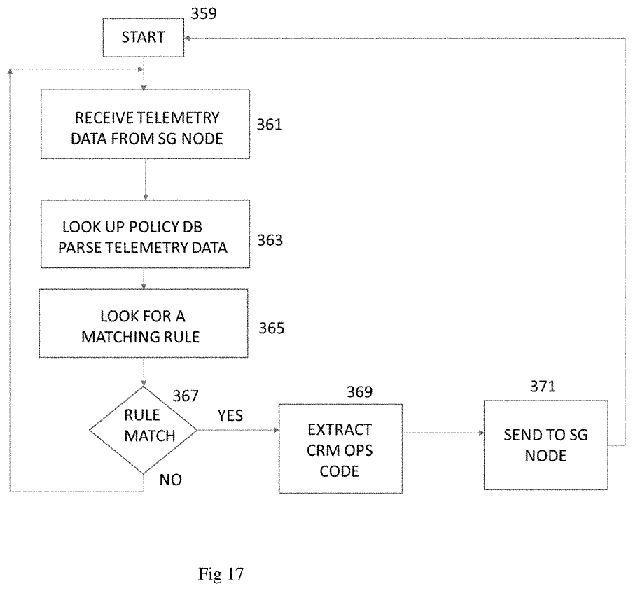

USC controller can initiate a data transfer stored at-rest in the data Nodes to be migrated to another geo location for any reason. The request hits the Data Node, which will in turn get each fragment of the data and send to DTC Node connected closer to it which can be statically, configured This first DTC Node, originating the data picks the data in the overlay network is called ingress or origin DTC. First DTC Node then identifies the destination DTC Node, which can be in another country. First DTC Nodes then pick a unique list of DTC Nodes which are located in different geo-locations and route the traffic to the next in the list, until it hits the last DTC Node, which is also called terminal DTC node, which will terminate the data and deliver to the data Node connected to it. The list of such node information can be represented by standard graph data structure. This is referred as node state graph or Exclusive Content Forwarding Router (ECFR) list. Last DTC node is called terminal DTC Node. DTC nodes are monitored for any intrusion events, which is referred as Intrusion Detection Events (IDE). Intrusions are responded by Real-time Intrusion Mitigation (RIM) operations. Referring to FIG. 15, which is a table that list simple example of an embodiment showing list of IDE on column 1. 1 such intrusion events is a Ransomware attack. On the second column, 03 is the RIM code. Internally, protected system can enumerate this to any system specific operation that needs to be executed in the protected system. Any insider theft event is responded with code 02 and so on. This table is just an example and can be extended to a wide array of configurable commands and corresponding response codes, which becomes custom real time IT operations. Referring to FIG. 17, a flow chart further illustrates this aspect of the present disclosure. At step 359, logic flow starts at USC. At step 361 it receives telemetry data from SG node. USC node then moves to parsing and processing step at 365 to find a configured rule, which is essentially a command code as explained above for RIM codes. At step 367 it decided to go back to start state as USC found nothing special to do or found matching rule and proceeds to step 369 where it extracts the code to execute the operation, which is referred as Contextual Risk Mitigation (CRM) code. Similar steps can be followed to protect any system forming the overlay network.

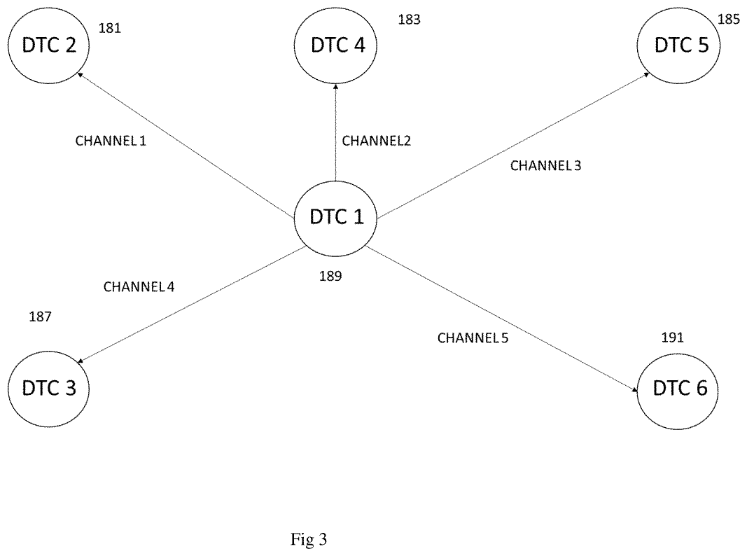

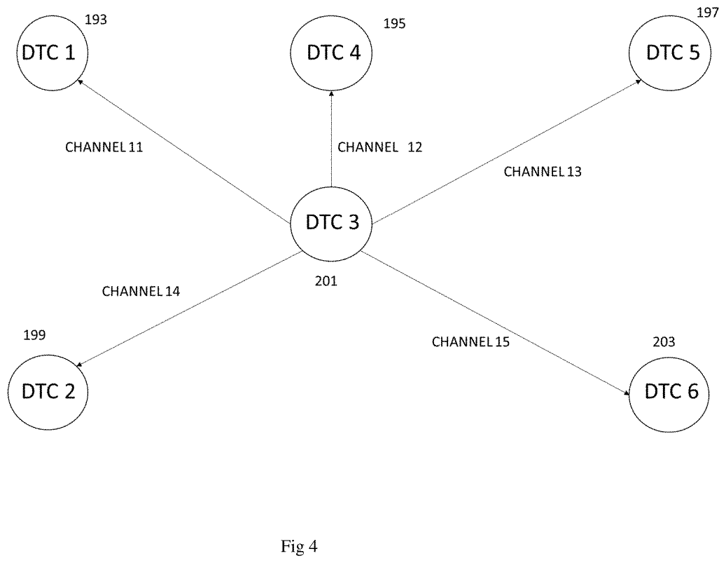

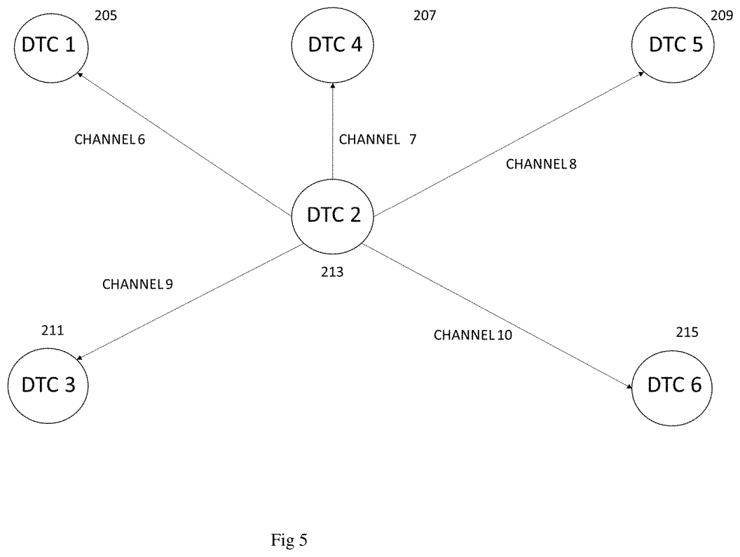

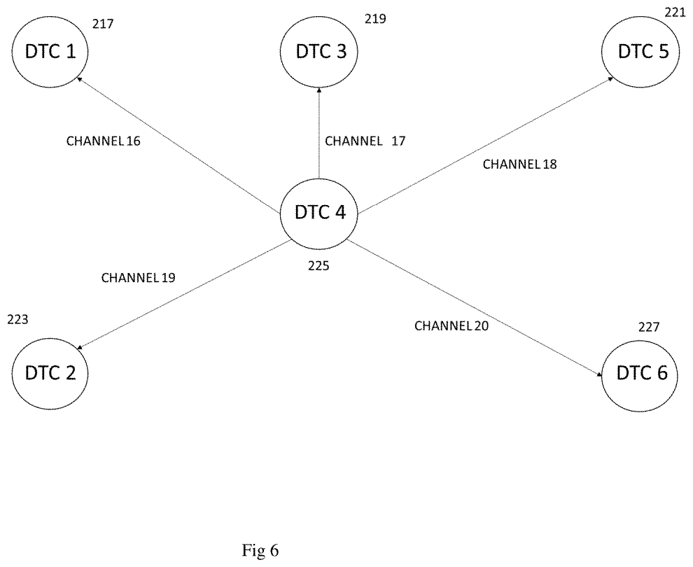

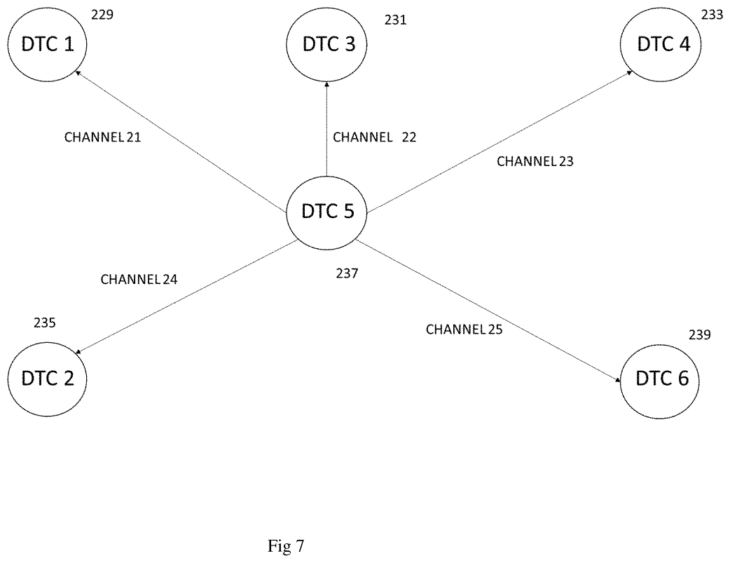

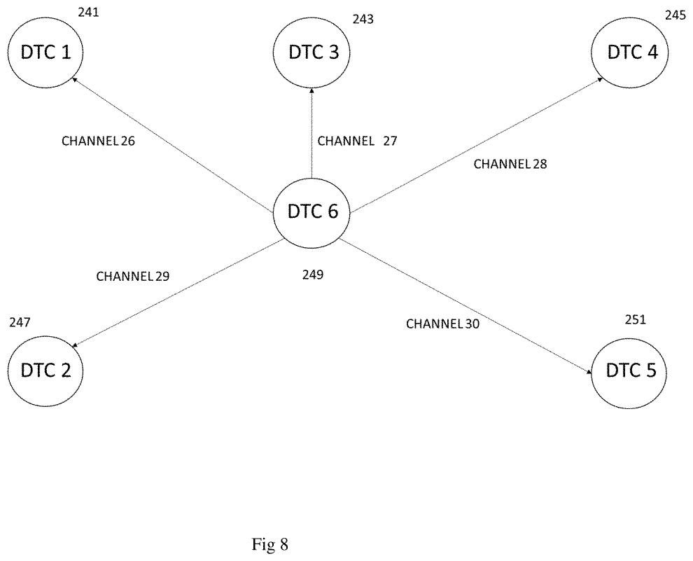

As each fragment is erasure code, information theoretic split of the data, data cannot be revealed even with a quantum computer, at least multiple paths are wire-tapped, which is making the attack theoretically less practical. FIG. 4, FIG. 5, FIG. 6, FIG. 7, FIG. 8 and FIG. 3, indicate connection states of each DTC shown in the exemplary embodiment. Every DTC Nodes makes a transport connection to every other DTC node participating in the forwarding of a given content. While present disclosure adds a new dimension of data routing at user content level, it still uses the underlying physical network routing mechanisms such as BGP or OSPF when the IP packets are routed through the underlay network infrastructure. Source path routing mechanism of IP layer is not well accepted, and Segment Routing has limited support in some MPLS network. Embodiments of the present disclosure make use of overlay routing at higher layers, making use of the observation that underlying packet routing make use of least cost path routing meaning, if a transport message is sent from US to Canada, it will never touch a Router in any country in India or Middle East. Embodiments of the present disclosure use this observation of transporting content across different application layer paths, selected in such a way that, it is practically unlikely to go through the same physical routers carrying traffic in two distinct path lists of the DTC Nodes. As the Embodiments of the present disclosure has the mechanisms of selecting “n” unique paths, with at least packets of m different paths have to go through a same network device along the path, where m can be larger than 3, Embodiments of the present disclosure provide sufficient guarantee of eliminating wiretapping or data exposure risk in-motion, the same way it provides data exposure risk at rest, in the context of quantum computer attacks

In some embodiments, overlay network can be constructed without a dedicated USC, as indicated by FIG. 10 and FIG. 12. In such embodiments, all DTC nodes run distributed peer to peer algorithms for route distribution and error updates.

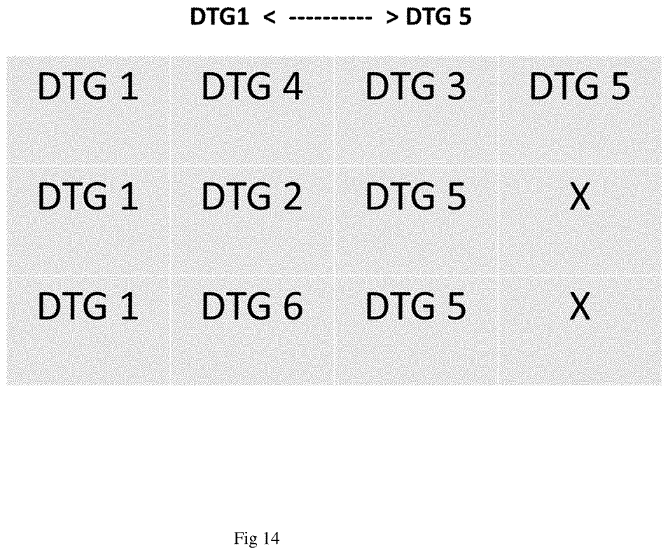

Referring to FIG. 14(Table), a data is moved from DTG 1 to DTG 5. It can take three fragments across three different paths as shown by the three-exclusive list of DTG nodes in the table in each row. First fragment goes through nodes DTG 4 and DTG 3 between source and destination. Second fragment goes through DTG2 and third one goes through DTG6. In a reed Solomon coding of 5 fragments, only 3 is needed for full recovery and follow three different paths. This minimal amount of SP fragments needing for full recovery is termed as minimal set SP fragment split-set. This number varies as the total number of fragments varies. This configuration aspects of RS coding is done during configuration time at USC.USC has wide array of configuration parameters that defines the list of remote CRM operations supported, information regarding connected SG nodes, connected CFR nodes and a static list of exclusive CFR lists showing exclusive CFR list for every DTC node to every other DTC nodes, with at least 2 exclusive paths between any DTC to any other DTC. As none of the paths has overlapping DTC Nodes, all SP fragments will be routed across the different network device, optimally by the underlying IP routing layers, though it can pass through same underlay network devices in theory if overlay nodes are sufficiently close by geographic locations. At every DTC, there is a configured list of exclusive paths to any other DTC for each SP fragment to be forwarded through, if content is originated at the DTC in question. As the present disclosure is routing content at application level, a wire-tapping intermediary cannot determine the full sequence of the content, because connection is setup and terminated for every fragment of the content, in addition to EP forwarding aspects. Every DTC there is an Rx process that receives the incoming fragment. First 1024 bytes of every fragment contains CFR List and information regarding the next DTC to be forwarded to. Every DTC node updates the header with the next DTC information in the CFR list as the next hop and forwards it to the next DTC. End to end CFR list is created for a new fragment at the first DTC controller. This process is defined as EP forwarding continues until the last DTC node is hit by the fragment. In this case, n is 5 and m is 3. As reed Solomon and its variants allow higher values such as n 90 and m 60, information theoretic algorithms can be modified to avoid the theoretical possibility of overlapping network devices, without overlapping DTC Nodes. Additionally, data can further be redacted with gaps in data, which is sent in different network path or anonymized or embedding gap blocks as explained earlier, with any existing data engineering methods to make the possibility to practically zero.

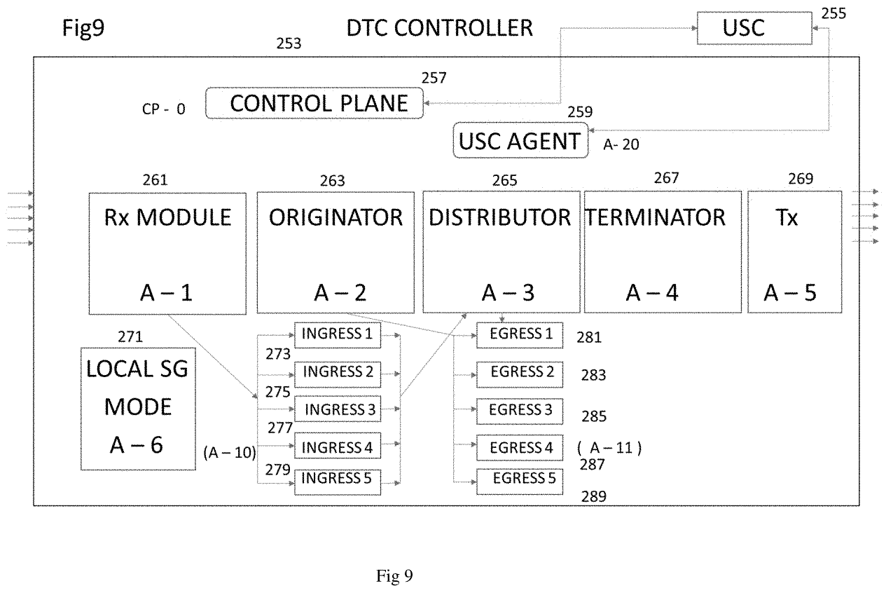

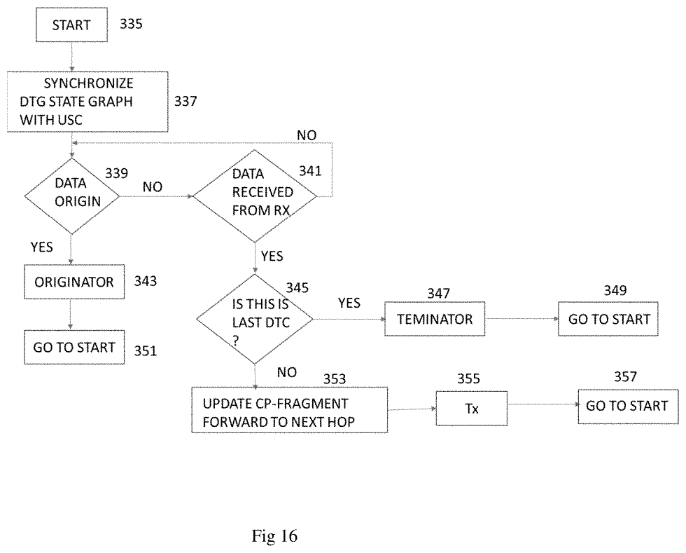

Referring to FIG. 9, a cross section of a specific DTC Node is explained. Control Plane, (labeled as 257) cp-0 receive various DTC route info updates and configures the DTC Nodes accordingly for the unique path selection logic. Rx (Receiver) module (labeled 261) A-1 receive the traffic from any of the connected DTC Nodes. Tx (Transmitter) module (labeled 269) will further forward the content to upstream DTC Nodes by looking up on the next hop table for each route id. Originator module (labeled as 263), A-1, will create the path list header and attach into the content if this is the first DTC Node of the data traffic. Role of originator is to prepare the content for forwarding by embedding the path lists or tagging the content with DTC ids or similar steps to attach route information to the content depend upon the actual implementation of the specific embodiment. Distributor module (labeled as 265), A-3, will do the role of updating the DTC path list headers and move to the egress queue for the upstream traffic. Terminator module, (labeled 267) as A-4 will terminate the traffic if the current DTC is the last DTC Node in the list and initiate the content delivery to the target Data Node. Role of the terminator module is thus to receive the traffic at the terminal DTC and to terminate the data forwarding operation. A-10 (labeled with (273,275,277,279 and 280) and A-11(labeled 281,283,285,287 and 289) are the ingress queue and egress queue respectively for the incoming and outgoing data traffic. A-6(labeled as 271) indicates data node in the local SG mode which can store data locally, within the DTC system itself as required by the specific aspect of the embodiment in question. A-20 (labeled as 259) is the USC agent running in DTC Nodes as the security end point from USC (labeled as 255). DTC Node system itself is monitored for any intrusion, binary content verification of DTC modules. If there is any violation is detected at USC, USC will initiate CRM operations that include bringing down the system as well. Referring to FIG. 16, a flow chart, 335 is the start step that includes starting the DTC node system itself. Step 337 indicates a synchronization phase of DTC with USC to get updated states of all DTC nodes in the overlay network. Essentially the list of all DTC nodes, also referred as CFR list or EPLT table, can be represented as a graph data structure as used for connected graph. Each DTC will initiate connections or send heartbeat messages in UDP protocol, to check the availability and reachability of other DTC nodes and USC. Each DTC then will update its local EPLT table and also Next Hop Table. This data can also be represented as a plain list of XML files for every other DST node. Each XML file can represent a list of all combinations of routes to a given destination. This list can further be pruned by weeding out the entries containing common DST nodes, other than the source and destination. This is how a CFR List is created, which is inserted whenever new content is originated from the DTC. DTC keeps track of any DTC node in the overlay being down or back in operation and updates the DTC graph state. This process runs in the control plane, like similar ways a packet router update the forwarding table when there is a routing information change happens. It includes the IP addresses of every DTC node, port numbers to be used to contact Rx module of every DTC. DTC updates the list of Content Forwarding Routers (CFR) through which DTC Node can move the content through. DTC and CFR refer to same entity in the present disclosure, using two terms to point to different aspects of the DTC (CFR). Every DTC can get an exclusive list of CFRs to reach to every other member, which refers to the CFR List. DTC then at step 339 check if the data originated its journey on this node, which is the case when connected SG nodes push the content to this node as the first node. If it is the case, it will execute the ORGINATOR module which will insert exclusive CFR List into each SP fragment. This can be at a fixed offset, typically before the fragment data start offset or any known offset. DTC nodes then push the fragment to egress queue and repeat the start step. This process is repeated for every SP fragment of the content. Only minimal set SP fragments need to be transmitted. DTC node checks if any data arrived from another DTC at step 341. If no data reception detected it goes back to start step. Otherwise, it checks if this is the last DTC in the CFR List at step 345. If this is the last node in the list, it has to terminate the fragment journey and wait for other fragments of the split-set to arrive, which is part of the fragment set represented in the initial header in the content. Once all fragments received, DTC will initiate content gap block request to receive the gap block metadata and gap block data. Using Gap block metadata, content offsets of the gap blocks are retrieved, and gap blocks are re-inserted and then retrieve the encryption key from the re-assembled content and CR operations begins. This is the logic of the terminator module. Every SP fragment will be preceded by an XML file, containing the original content name, total fragments needed, final destination DTC, next hop DTC information to facilitate all hop by hop and end to end processing. DTC information can be as simple as a DTC ID. DTC ID can be any unique no which can be configured at USC, which is distributed to all DTC. DTC is also referred as CFR interchangeably, as every DTC not as the first or the last DTC, it is functioning only as a forwarding node (Content Forwarding Router). Initial fragment header containing CFR List is only created at the first DTC.

If this is not the last DTC, at step 353, it will then advance the CFR List by one node and update the next Node information as the next hop CFR and update the CP fragment header as inserted by the ORIGINATOR and it transmit the fragment to next hop at step 355 and goes to start phase at step 357.

Any CFR node can fail at any time. USC agent module will detect any failure and communicate to USC controller. USC controller then updates all the unreachability info to all other connected CFR nodes. USC also deduce CFR node failures at hardware level when periodic communication messages from USC module running on a particular node not arrived in pre-determined time duration, such as 2 minutes for example. In both cases, node failures are detected and communicated to all other nodes. Each CFR node in turn will update its node state information and also recalculate state data graph with the update information on available node states. CFR forwarding modules will then forward the SP fragments accordingly. State data graph can calculate more than one back up paths also, to re-route the SP fragments if any failure in transmission. Back up paths can be determined hop to hop basis or end to end basis. The initial, statically created or pre-computed Node states information can be distributed amongst all nodes through a centralized manner or through a peer-to-peer node state publish model which forms the initial, pre-computed state data graph. In at least one embodiment, USC controller maintains all information about all CFR nodes which can be shared with all connected CFR nodes in real time, whenever there is change of state happens. Once every node has information about all other nodes, each node can independently build the state data graph containing exclusive list of paths for reaching any CFR node from every other CFR node. Any path is pruned out from the list, if any CFR node is repeated in the list that is already included in another path list from connecting the same source node and end node.

Each entry in the state data graph is referred as Path List Table entry or PLT Entry. CFR periodically send message to all CFRs forming each exclusive path and if any of the CFR is not reachable or found in another path, it is removed from the path list, a process referred as Route List Pruning or RLP. Path List Table can be generated manually or dynamically through existing graph theory algorithms at USC, a process referred as PLT generation. Once PLT is prepared through static method or graph theory method based on the information on all the CFR identifiers and their reachability information entered through any administrative procedures, CFR that periodically contacts USC to download the list of all CFRs connected in the overlay. This process is known as CFR Route Pull. It then prepares different set of CFR list for each fragment of the content to be forwarded through. This process is called Exclusive Path List Table generation which is explained later in the disclosure.

Referring to Table 14, various paths from DTG1 to DTG5 (CFR is also referred as DTG in the disclosure). DTG1, DTG2, DTG3, DTG4, DTG4, DTG5 and DTG6 represent DTCs located widely distributed enough to cause underlay data packets move through different network devices, when transport layer data streams flow through these DTC nodes. In the first list, content will be routed through DTG4 and DTG3. Second path includes content forwarding through DTG 2 and third is DTG 6. This combination of Exclusive list of DTGs or Exclusive Content Forwarding List (ECFR) can be prepared using any of the basic algorithms of unique set preparations. Each path is now become a virtual circuit of unique set of CFRs, and also referred as Exclusive Path Circuit (EPC) in the disclosure. Each line in the table is a Path List Table Entry (also referred as PLT Entry) which is separately downloaded at CFR module of DTC from USC or can be learned through CRP Operation. CFR will run availability tests and if any CFR which is part of a PLT entry is not reachable, or USC determines that it was cyber-attacked through IDE event processing, that path is removed from the active list of CFR List. So Redundant path List is prepared by USC that is downloaded to CFR through CFR Route Pull (CRP) operation. CRP operation essentially a series of network transfer of each PLT entry or full list in any format. Once such format can be as simple as an XML file containing the list of entries. And this XML file containing the exclusive rote list can be downloaded at CFR using any file transfer methods, through a connection initiated by CFR. A key data structure of the route preparation is Route ID. Each pair of a source CFR and a destination CFR is assigned a unique Route ID. And at least 2 PLT entries are generated for each Route ID at USC. Information about any new CFR is entered statically at USC or can be learned dynamically through CFR join operation, which essentially transmits the location country, IP information, listening port to USC. USC can then pick the newly joined CFR for establishing the path circuit going through that location. Route List Pruning (RLP) operation is executed at CFR whenever it detects the failure of a Node in the list or when CFR receive a message from USC on a security incident detected at a given CFR, through a CRM operation initiated at USC. Each DTC then prepares the next HOP data for each Route identifier, which is used in up-stream data-forwarding.

USC agent module running in DTC node constantly communicates to USC controller through various heart beat messaging mechanisms. When through AIOps mechanisms any DTC node found to be attacked by any ransomware or insider activity, this particular DTC node will be marked as unavailable in the overlay network and same process logic is executed. Whenever there is a missing heartbeat messages or keep-alive message are lost, the DTC node in question is marked as unavailable and sequence of events that follow will initiate distributed updates of CFR lists on those DTC nodes having the affected DTC as part of its local PLT table. As AIOps drive the dynamic routing information exchange against any failures or cyber-attacks, this the present disclosure provides novel ways of dynamically configuring the content forwarding routers with the right set of content routing data to move data safely and securely. If more than one DTC nodes are detected with malicious cyber-attacks or abnormal system activity, USC controller can inform all DTC nodes to stop the content origination and forwarding altogether. The present disclosure also can be applied to L3 level packet routing devices as well. Backup routing or automatic re-route of any content is facilitated at DTC node level or at entire end to end path level. DTC node level content re-routing is done by distributor module while end to end path level re-routing is done by originator only. USC will calculate backup nodes for each DTC node, determine node state information for all DTC nodes and mirror path of every unique path list from every DTC node to every other DTC node and store it in its routing information base. USC agent module then syncs it to every DTC node for its proper functioning. Whenever a new DTC node is added to the system, it can be configured as a primary node or as a backup node for any primary node. If a primary fails, USC will notify all other nodes on the new role of the backup node. Whenever a new node joins the overlay, USC agent has to authenticate and verify its digital credentials to participate in the overlay.

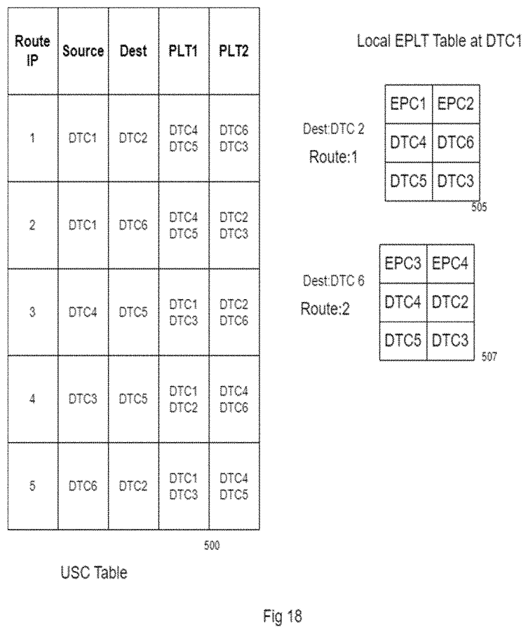

Referring to FIG. 18, which shows a master EPLT table, 500 containing distinct paths for 5 Route identifiers. Route 1 is for DTC1 to DTC2, Route 2 is for DTC1 to DTC 6, Route 3 is for DTC4 to DTC5, Route 4 is for DTC3 to DTC5 and Route 5 is for DTC6 to DTC2. Each Route has two separate lists, labeled as PLT1 and PLT2. For example, PLT1 for DTC1 to DTC2 is DTC4 and DTC5. This means that one path of content transmitted from DTC1 to DTC2 will go through DTC4 and DTC5. Thus, a virtual circuit is established from DTC1 to DTC2, through DTC4 and DTC5, forming two intermediate HOPs at transport level, which is also referred as exclusive path circuit (EPC). Content will be transmitted from hop to hop on separate transport connections, on a split-transport manner, unlike traditional WAN data transfer where transport layer is processing data only at the source and final destination. Instead of a single end to end transport from the origin DTC to terminal DTC, transport connections are split across all DTC nodes which are part of forwarding the content in the overlay. This is a radical departure from the theory of end to end paradigm of transport protocols where transport connection state is handled only on the source and destination of application layer protocol data units (PDUs).

Referring to FIG. 18 again, 505 and 507 are the local tables or PLT entries of DTC1 as the source DTC (also referred as origin DTC), for destinations DTC2 and DTC6 respectively. When content is destined for DTC2, with Route ID assigned as 1, there are two EPCs available, one through DTC4 and DTC5 (as indicated by EPC1 label) and DTC6 and DTC3 as indicated by EPC2 to reach the destination DTC (or also referred as terminal DTC). Similarly, table 507 illustrate the table of local PLT entries for the destination DTC6, having Route ID assigned as 2, with two distinct paths labeled as EPC3 and EPC4 with Content Forwarding Router (CFR) List as DTC4, DTC5 and DTC2, DTC3 Respectively. Route ID is unique identifier that is used across USC table and local DTC table.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

I claim:

1. A method for implementing an overlay network of Data Transport Controllers (DTC nodes) with source-routed data forwarding across DTC nodes, based on transport protocol information with split-transport, the method comprising:
populating and updating content forwarding data (CFR list) to establish exclusive paths to forward content, across Data Transport Controller (DTC) nodes, at regular intervals using a universal security controller (USC);
uploading the user content to original Data Transport Controller (DTC) nodes,
converting the uploaded content into Split-Partition (SP) fragments at origin DTC,
preparing the SP fragments for data forwarding operation at origin DTC,
executing data-forwarding operation by a plurality of DTC nodes,
receiving the SP fragment at terminal DTC,
recovering the original content from the SP fragments at terminal DTC node.

2. The method as claimed in claim 1, comprising populating and updating content routing information to DTC nodes at regular intervals using a universal security controller (USC); wherein all DTC nodes are communicatively connected to one another and to USC and comprising the additional steps of:
creating Exclusive Path List Table (EPLT) through PLT Generation operation, at USC,
Preparing Route Identifiers, at USC,
Assigning separate set of CFR List for each Route Identifier at USC,
exchanging the CFR List and Route Identifiers to DTC nodes through CRP (CFR Route Pull) operation at any DTC node,
executing Route List Pruning (RLP) operation at every DTC node,
creating the exclusive content forwarding router (ECFR) List for content forwarding, at DTC node,
preparing next hop table for every Route ID at DTC node,
establishing transport level connection to next hop DTCs, at DTC node,
forming the split-connected, exclusive path circuit (EPC) mesh for every route identifier,
receiving content from any other DTC in an exclusive path list, at any DTC node,
executing data-forwarding operation at DTC node,
executing data termination operation at terminal DTC node,
whereas data nodes and DTC nodes are communicatively connected together in a Wide Area Network or part of the same system and exchange control commands, security parameters, configuration parameters with USC.

3. A method for exchanging data across transport level content routing overlay architecture, built upon a plurality of Data Transport Gateways (DTC nodes) and a Centralized Security and Route distribution controller (USC) communicatively connected to one another and the method comprising:
populating and updating content forwarding data to DTC nodes at regular intervals of time using a universal security controller (USC),
forwarding SP fragments across a plurality of DTC nodes,
wherein the DTC nodes are connected through an underlay network running existing routing protocols based on lower layer protocol information such as IP or MPLS labels, and comprising the steps of:
creating Exclusive Path List Table (EPLT) through PLT Generation operation, at USC,
exchanging the PLT Entries to every DTC node through CRP (CFR Route Pull) operation between DTC node,
executing Next Hop Update (NHU) operation at DTC node,
executing Route List Pruning (RLP) operation at DTC node,
creating the exclusive content forwarding router (ECFR) List for content forwarding, at any DTC node,
preparing next hop table for every Route ID at DTC node,
establishing transport level connection with next hop DTC nodes,
forming the split-connected, exclusive path circuit (EPC) mesh for every Route Identifier, whereas data nodes and DTC nodes are communicatively connected together in a Wide Area Network or part of the same system and exchange control commands, security parameters, configuration parameters with USC.

4. A method for forwarding content across DTC nodes, across an overlay network, the method comprising,
converting the content into SP fragments, and sending SP fragments to any DTC node from Data nodes;
forwarding split partition (SP) fragments across a set of exclusive list of DTC nodes, using a plurality of DTC nodes;
storing the SP fragments, using a plurality of Data nodes before or after being transported over the overlay; and
populating and updating content forwarding paths to DTC nodes at regular intervals of time using a universal security controller (USC), wherein the USC node exchanges executable instructions with DTC nodes, all DTC nodes are connected through an underlay network running existing routing protocols, and further comprising the steps of:
preparing Exclusive Path Routes to every other DTC node,
updating the SP Fragments with separate DTC List for each SP fragment, through Route-Selection operation,
executing exclusive path forwarding (EPF) operation of each SP fragment from origin DTC node to terminal DTC node in the DTC List
receiving the SP fragment at the terminal DTC, whereas data nodes and DTC nodes are communicatively connected together in a Wide Area Network or part of the same system and exchange control commands, security parameters, configuration parameters with USC.

5. A method for Exclusive-Path content forwarding across an overlay network, the method implemented by a computer system that includes a processor coupled to a memory comprising a plurality of DTC nodes communicatively connected across one another and to a USC controller; DTC node comprising the instructions for
establishing transport level connections to any of the DTC node and USC, executing Route-Learning operation,
creating the exclusive content forwarding router (ECFR) List for content forwarding,
creating Path List Table (PLT) through PLT Learning operation,
exchanging the PLT Entries to every DTC node through CRP operation between any of the DTC node and USC,
executing Route List Pruning (RLP) operation at every DTC node at regular intervals,
preparing Exclusive Path Routes to every other DTC nodes updating the content with separate DTC List,
executing exclusive path forwarding (EPF) operation for content,
terminating the EPF at terminal DTC node, whereas data nodes and DTC nodes are communicatively connected together in a Wide Area Network or part of the same system and exchange control commands, security parameters, configuration parameters with USC.

6. A system for Cyber-Secured, Exclusive Path Routing at transport protocol level, the system comprising
a plurality of data nodes either connected to DTC nodes or a part of DTC node for converting content into SP fragments and uploading to DTC nodes, and
a universal security controller (USC) that populates and updates content forwarding data to DTC nodes at regular intervals of time, wherein all DTC nodes are connected through an underlay network running existing routing protocols based on lower layer protocol information such as IP or MPLS labels, and comprising USC having the instructions for:
creating Exclusive Path List Table (EPLT) through PLT Generation operation and executing CRM operations at every DTC,
a plurality of DTCs connected across a Wide area network over a transport protocol having the instructions for,
exchanging the PLT Entries to every DTC node through CRP (CFR Route Pull) operation at any DTC node,
executing route selection operation at USC,
executing Next Hop Update (NHU) operation at DTC,
executing Route List Pruning (RLP) operation at DTC node,
creating the exclusive content forwarding router (ECFR) List for content forwarding, at any DTC node,
preparing next hop table for every Route ID at every DTC,
establishing transport level connection with next hop DTCs,
forming the split-connected, exclusive path circuit (EPC) mesh for every Route Identifier, whereas data nodes and DTC nodes are communicatively connected together in a Wide Area Network or part of the same system and exchange control commands, security parameters, configuration parameters with USC.
